(19) United States
(12) Patent Application Publication
(10) Pub. No.: US 2012/0320942 A1
(43) Pub. Date: Dec. 20, 2012

(54) METHOD FOR OPERATING AN ARC FURNACE, CONTROL AND/OR REGULATING DEVICE FOR AN ARC FURNACE, AND ARC FURNACE

(76) Inventors: Björn Dittmer, Nurnberg (DE); Arno Döbbeler, Herzogenaurach (DE); Klaus Krüger, Hamburg (DE); Sascha Leadbetter, Munchen (DE); Thomas Matschullat, Eckental (DE); Detlef Rieger, Baldham (DE)

(21) Appl. No.: 13/580,885

(22) PCT Filed: Feb. 1, 2011
(86) PCT No.: PCT/EP2011/051409

§ 371 Date: Aug. 23, 2012

(30) Foreign Application Priority Data
Feb. 23, 2010 (EP) 10001823.3

(51) Int. Cl. H05B 7/148

(52) U.S. Cl. 373/104

(57) ABSTRACT

An arc furnace, a control and/or regulating device for an arc furnace, and a method for operating an arc furnace are provided, wherein an arc for melting metal is generated by at least one electrode, wherein an arc associated with the electrode(s) has a first radiation power based on preselected operating parameters, wherein the arc furnace is operated according to a predefined operating program based on an expected process sequence, wherein monitoring is performed to detect whether an undesirable deviation exists between the actual process sequence and the expected process sequence. Because a modified second radiation power is specified if a deviation is present, and a modified second set of operating parameters, e.g., impedance value(s), is determined based on the modified second radiation power, a method is provided that permits a minimal melting time while minimizing consumption of operating resources, e.g., with respect to arc furnace cooling.

### CROSS-REFERENCE TO RELATED APPLICATIONS

This application is a U.S. National Stage Application of International Application No. PCT/EP2011/051409 filed Feb. 1, 2011, which designates the United States of America, and claims priority to EP Patent Application No. 10001823.3 filed Feb. 23, 2010. The contents of which are hereby incorporated by reference in their entirety.

### TECHNICAL FIELD

This disclosure relates to a method for operating an arc furnace, wherein an arc for melting metal is generated by means of at least one electrode, wherein an arc which is associated with the at least one electrode has a first radiation power based on a first preselected set of operating parameters, wherein the arc furnace is operated in accordance with a predefined operating program which is based on an expected process sequence, wherein monitoring is performed to detect whether there is an undesirable deviation present between the actual process sequence and the expected process sequence. The disclosure also relates to an associated control and/or regulating device for an arc furnace, as well as to an arc furnace.

### BACKGROUND

During the production of steel in an electric arc furnace, scrap metal is generally melted using a permanently stored operating program in which the setpoint values of the electrode regulating system (for example in the form of current or impedance setpoint values) are predefined. Said setpoint values are designed to ensure the process attains a high level of productivity and cost-effectiveness and in most cases are based on empirical values. Since the scrap metal that is to be melted down has varying properties, the operating program should ideally be adapted to match the real-world process sequence. Thus, the mass of scrap metal material can have a differing bulk density both locally and as a whole, which has an impact on the speed at which the melting operation progresses.

The electrical operating point should in all cases be adjusted to the actual progress of the melting operation in order to avoid excessive energy losses. Basically, this can be accomplished in different ways depending on how the control and/or regulating system of an electric arc furnace is implemented. In most cases the associated parameters are the reactance of a choke coil that can be switched in stages, the secondary outer conductor voltage/voltages of a furnace transformer that is switchable in stages, and the arc current or impedance by way of the setpoint values for the electrode regulating system.

The melting process can be controlled by way of these actuating variables. Said variables are usually predefined by way of an operating diagram or program as a function of the energy introduced.

If the process sequence deviates from the expected sequence which is mapped in the operating diagram, operating personnel should intervene in the automated workflow by way of the above-cited actuating variables.

In the event of a symmetric deviation, i.e. a deviation affecting the entire furnace, this can happen taking into account the rated load of the operating resources, e.g. by uniform or symmetric modification of the impedance setpoint values. If, on the other hand, only a few regions of the furnace are affected by a deviation from the expected melting process, a more differentiated approach must be adopted.

If the mass of scrap metal material is melted down faster in one region of the furnace, a targeted response should be initiated thereupon in order to take account of said asymmetric process development. Such a difference in the melting behavior of different regions of the furnace vessel can be caused e.g. by local inhomogeneities in the scrap metal addition, resulting in the formation of particularly hot areas (hot spots) in the furnace vessel. The different radiation and shielding of the arcs can be obtained e.g. by the temperature distribution of the panels or, more effectively and faster, by calculation of the shielding factors, as described in the unexamined German patent application publication WO 2009095396 A1.

A reduction in the melting performance of the entire arc furnace would unnecessarily prolong the process time and consequently lower productivity. Rather than reducing the melting performance it may be advantageous to redistribute it in the vessel in such a way that higher radiation power is applied to the regions having large amounts of unmelted scrap metal.

A reduced shielding of individual arcs, resulting in undesirable heating of opposite panels due to the radiation, should conversely lead to the radiation power being reduced. Depending on the embodiment of the furnace, such an asymmetric distribution of the radiation power can be accomplished in different ways.

A deviation from the management of the process predefined by the operating program is carried out in two ways. Firstly, the operating personnel can intervene manually in the process workflow based on personal experience or in response to warning messages. Secondly, an adjustment to the current progression of the process can be made on the basis of feedback from the process, mostly implemented in the form of an evaluation of the thermal status of the panels of the furnace vessel. In this way the electrical operating point can be controlled and/or regulated in an automated manner in the form of electrical setpoint value specifications. Such a power adjustment usually takes place symmetrically in all three phases.

In the case of the last-cited automated control and/or regulating approach it is calculated on the basis of the thermal status how the melting performance of the arcs should be modified. Different studies have shown that the melting performance of the arcs is essentially characterized by convection and thermal radiation. In the present case considering the melting performance directly at the wall elements or the scrap metal disposed in front thereof, the radiation power emitted by the arcs in particular is of interest.

A small number of automated solutions also make provision for the asymmetric adjustment of the setpoint value specifications. Toward that end, the setpoint values of the strand impedances are adjusted according to heuristic rules or else nonsymmetric furnace voltages are also chosen given a suitable furnace transformer. A direct predefinition of the desired radiation distribution has not been possible to date in the prior art. Starting from the chosen impedances, the achieved radiation distribution can subsequently be determined by way of empirical models.

It is furthermore known that the calculation of the electrical variables, based on which the radiation power is then estimated, is performed on the basis of a linearized, simplified equivalent circuit of the electric arc furnace; cf. e.g. S. Köhle, Ersatzschaltbilder und Modelle des Hochstromsystems von Drehstrom-Lichtbogenöfen (“Equivalent circuits and models of the high-current system of three-phase current arc furnaces”), Stahl und Eisen 110, pages 51 to 59. A more thoroughgoing approach is to link the thus found radiation powers with a circle diagram, e.g. known from Gortier et al., “Energetically Optimized Control of an Electric Arc Furnace”, IEEE International Conference on Control Applications, Taipeh, Taiwan, pages 137 to 142.

A method for regulating and/or controlling a melting process in a three-phase current arc furnace is known from DE 197 11 453 A1. In this case the temperature in the vicinity of an electrode is measured and the effective power of the electrode is set on the basis of the measured temperature. A disadvantage with this solution is that a control intervention will not be initiated until after overheating of the furnace has already occurred. Furthermore, the active electrical power only indirectly effective for the temperature increase is controlled.

### SUMMARY

In one embodiment, a method is provided for operating an arc furnace, wherein an arc for melting metal is generated by means of at least one electrode, wherein an arc associated with the at least one electrode has a first radiation power based on a first preselected set of operating parameters, wherein the arc furnace is operated in accordance with a predefined operating program which is based on an expected process sequence, wherein monitoring is performed to detect whether there is an undesirable deviation present between the actual process sequence and the expected process sequence, wherein if there is a deviation present a modified second radiation power is specified, and a modified second set of operating parameters, in particular at least one impedance value, is determined on the basis of the modified second radiation power.

In a further embodiment, the second set of operating parameters is determined iteratively. In a further embodiment, a first model for determining a radiation power from electrical variables is used for the iterative determination. In a further embodiment, in addition use is made of a second model by means of which variables, in particular the impedance, indirectly influencing the radiation power are transformed into electrical variables, in particular arc current and/or resistance, directly influencing the radiation power. In a further embodiment, for the transformation the second model uses an electrical equivalent circuit for the arc furnace. In a further embodiment, compliance with secondary conditions, in particular technical limitations of the arc furnace operation, is taken into account during the determination of the modified second set of operating parameters. In a further embodiment, the modified second radiation power is specified as a function of a shielding of the arc that is present in the arc furnace. In a further embodiment, the modified second radiation power is specified as a function of a distribution and/or degree of fragmentation of metal scrap material prevailing in the arc furnace.

In a further embodiment, the arc furnace has three electrodes, each of which is associated with an arc, wherein if there is a deviation present for at least two, preferably each, of the three arcs a modified second radiation power is specified in each case, on the basis of which second radiation power a second set of operating parameters is determined for at least two, preferably for each, of the three arcs. In a further embodiment, the radiation power of at least two arcs is modified, wherein the sum of the individual radiation powers of the arcs associated with the three electrodes is substantially the same before and after modification of the radiation power. In a further embodiment, the arc furnace has three electrodes, each of which is associated with an arc, wherein if there is a deviation present a modified second radiation power is in each case specified for each arc, and a common set of operating parameters, in particular impedance values, is determined on the basis of said second radiation powers, such that each arc achieves the specified radiation power. In a further embodiment, the radiation power for the three arcs is specified in such a way that a thermal loading of the arc furnace, in particular of the cooling elements of the arc furnace, is reduced, in particular minimized.

In another embodiment, a control and/or regulating device for an arc furnace comprises a machine-readable program code which has control commands which upon being executed induce the control and/or regulating device to perform any of the methods disclosed above.

In another embodiment, an arc furnace is provided for melting metal, having at least one electrode, preferably three electrodes, for generating an arc, having a control and/or regulating device as disclosed above, wherein the control and/or regulating device is operatively connected to means for setting a radiation power and/or variables influencing the radiation power.

### BRIEF DESCRIPTION OF THE DRAWINGS

Example embodiments will be explained in more detail below with reference to figures, in which:

FIG. 1 shows a schematic flowchart of a method according to an example embodiment,

FIG. 2 shows a diagram of an example complete linear equivalent circuit for an arc furnace,

FIG. 3 shows equations for calculating the arc currents for a clockwise-rotating three-phase system,

FIG. 4 shows an impedance space containing a surface, wherein elements of the surface always supply one and the same constant radiation power for a specific strand, and

FIG. 5 shows two isosurfaces of the radiation power in the impedance space for two different strands.

### DETAILED DESCRIPTION

Some embodiments provide an operating method, an arc furnace, and a control and/or regulating device for an arc furnace which permit as short as possible a melting time to be achieved while minimizing consumption of operating resources, in particular in respect of arc furnace cooling.

For example, some embodiments provide a method for operating an arc furnace, wherein an arc for melting metal is generated by means of at least one electrode, wherein an arc associated with the at least one electrode has a first radiation power based on a first preselected set of operating parameters, wherein the arc furnace is operated in accordance with a predefined operating program, wherein monitoring is performed to check whether the predefined operating program is being maintained, wherein if there is a deviation in operation from the predefined operating program a modified second radiation power is specified, and a modified second set of operating parameters, in particular at least one impedance value, is determined on the basis of the modified second radiation power. The setting of the determined second set of operating parameters in particular leads to the specified modified second radiation power being achieved.

With some embodiments, it is no longer necessary for the operating parameters which exert an influence on the arc, in particular impedance values, to be approximated iteratively to an optimum on the arc until a desired radiation power for the at least one electrode is present.

Rather, it is possible directly and precisely to select a desired set of operating parameters, in particular impedance values, which also precisely delivers the desired radiation power for the at least one electrode, e.g., for three electrodes.

An iterative solution of the model in particular permits iterations to be avoided during the setting of the impedance. After the impedance value set for a predefined radiation power has been identified, said values can be set directly.

Iterative adjustments of the set impedance values are unnecessary, as a result of which the operating dynamics of the arc furnace are improved and the time that elapses until an optimal operating state is reached is reduced.

For the iterative determination, a first model may be used to determine a radiation power from electrical variables and in addition use is made of a second model by means of which variables, in particular the impedance, indirectly influencing the radiation power are transformed into electrical variables, in particular arc current and/or resistance, directly influencing the radiation power. The electrical variables associated with a predefined radiation power can be particularly suitably determined by this means.

For the transformation, the second model may use an electrical equivalent circuit for the arc furnace. This enables the behavior of the arc furnace to be satisfactorily approximated to reality.

Compliance with secondary conditions, in particular technical limitations of arc furnace operation, may be taken into account during the determination of the modified second set of operating parameters. This leads to only meaningful sets of operating parameters being determined, i.e. sets of operating parameters which can also be set in a suitable manner. This avoids “academic” results which could not be realized with the arc furnace due to technical constraints.

It may be advantageous if the modified second radiation power is specified as a function of a shielding of the arc that is present in the arc furnace. It may be advantageous to monitor a shielding of the arc, and if an undesirable shielding for an arc is present, e.g., if the shielding is less than a limit shielding for a specified time period, the first radiation power is changed to a second radiation power, in particular in such a way that the thermal loading of the furnace wall is reduced as a result of the arc having a reduced shielding. Thus, a response to an undesirable state in the arc furnace can be initiated at a very early stage, i.e., significantly before a temperature increase is detectable for the arc cooling system. In the prior art such a response cannot be initiated until much later, in particular only when the thermal load has led to an increase in temperature and consequently the corresponding components have already been exposed to a considerable thermal load. By means of the approach described it is possible to reduce the thermal loading of the furnace wall significantly, since it is not necessary to wait for an increase in temperature in order to trigger a response.

The modified second radiation power may be specified as a function of a distribution and/or degree of fragmentation of metal scrap material prevailing in the arc furnace. This enables e.g. the energy input to be maximized for that electrode which burns e.g. on solid, large and bulky scrap metal parts so that the latter can be melted down more quickly.

The arc furnace may have three electrodes, each of which is associated with an arc, wherein a modified second radiation power is specified in each case for at least two, and in some cases each, of the three arcs if there is a deviation present, on the basis of which second radiation power a second set of operating parameters is determined for at least two, and in some cases for each, of the three arcs.

It may also be advantageous if the arc furnace has three electrodes, each of which is associated with an arc, wherein a modified second radiation power is specified in each case for each arc if there is a deviation present, and a common set of operating parameters, in particular impedance values, is determined on the basis of said second radiation power, such that each arc achieves the specified radiation power.

The radiation power may be specified for the three arcs in such a way that a thermal loading of the arc furnace, in particular of the cooling elements of the arc furnace, is reduced, in particular minimized.

In view of the disadvantages of the prior art there is a need for a method for estimating or calculating the melting performance and in particular the radiation power of the arcs in the electric arc furnace.

Toward that end a model is used which enables said power to be distributed in a defined manner in the furnace vessel. The actuating variables by means of which this can be achieved are in principle the setpoint values of the strand impedances or electrical variables corresponding hereto. For this situation a method must therefore be found whereby the radiation power of the arcs can be varied in a targeted and defined manner by means of said actuating variables.

Various models can be used for calculating the radiation power of the arc in the electric arc furnace.

It may be advantageous to employ a model which has been derived from empirical measurements and physical considerations. Such a model is published for example in Dittmer et al., Modelltheoretische Untersuchungen zur thermischen Strahlungsbelastung in Lichtbogenöfen (“Model-based theoretical investigations of thermal radiation load in arc furnaces”), elektrowarme international 67 (2009) No. 4, pages 195 to 199, in equation 12 or in an extended version in equation 14. According to the model, the radiation power can be calculated given knowledge of the arc current and the arc resistance or arc voltage.

$$Φ ∼ \frac{{U}_{B}}{\sqrt[8]{I}} = {I}^{0.875} {R}_{B} . \qquad ( 1 )$$

(UB arc voltage, I current, RB arc resistance)
Correction by voltage drop and bath indentation:

$$Φ ∼ \frac{( {U}_{B} - 80 V )}{\sqrt[8]{I}} . \qquad ( 1 a )$$

The calculation of the occurring currents as a function of the electrical setpoint value specifications is performed on the basis of a complete, linearized equivalent circuit of the arc furnace. This also takes into account the primary-side elements, such as e.g. a choke, a reactive power compensation system and, if necessary, the impedance of the primary-side voltage supply. On the basis of the equivalent circuit it is now possible, for a given transformer and choke stage, to calculate, for each combination of impedance setpoint values of the regulating system of the arc furnace, the arc currents and arc resistances or voltages occurring for this operating point for each arc and consequently, using the radiation power model (equation 1 or 1a), to determine the correct radiation powers of the arcs. The method for calculating the arc currents and voltages is outlined here:

Firstly it is necessary to split up the impedance setpoint values Z_{Si} for each strand i in order to calculate the resistance of the respective arc R_{Bi}. For this, the general relationship between R_{Bi} and the reactance of the arc X_{Bi} must be known. The setup

X_{Bi}=aR_{Bi}+bR_{Bi}²

with the furnace-specific constant factors a and b can be used by way of example. This enables the arc resistance R_{Bi} associated with an impedance setpoint value Z_{Si} to be calculated taking into account the secondary-side reactance X_{Li} and resistance R_{Li} of the supply line losses. In the case of the above setup a fourth-degree polynomial must be solved for this purpose after R_{Bi}.

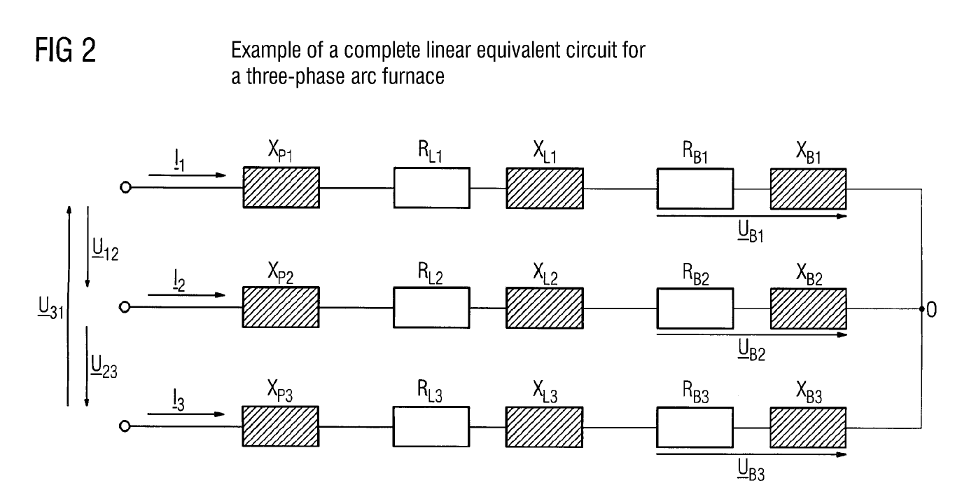

Accordingly, all secondary-side electrical variables required for calculating the currents settling into a steady state are known. Given knowledge of the primary-side reactances X_{Pi} and resistances R_{Pi}, the complete linear equivalent circuit can be set up for the respective three-phase arc furnace, as shown by way of example in FIG. 2.

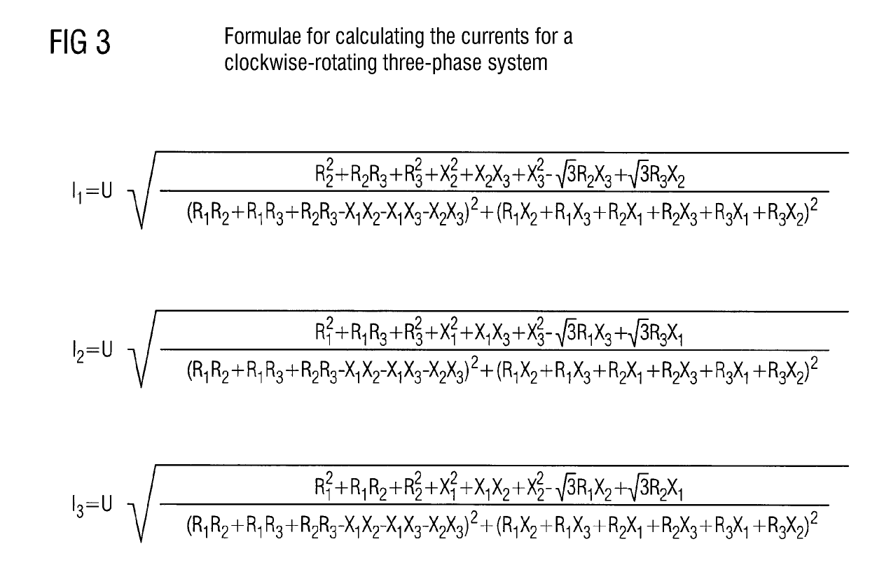

This enables the currents Iᵢ to be calculated for known outer conductor voltages, e.g. U₁₂ between strand 1 and 2. Given knowledge of the phase sequence of the three-phase system, the currents, as shown according to FIG. 3 for a clockwise-rotating system, can be calculated. For clarity of illustration purposes, the reactances of a strand are combined into Xᵢ and the resistances into Ri for that purpose.

Given knowledge of the currents, the effective voltage across an arc U_{Bi} can also be calculated.

U_{Bi}=R_{Bi}Iᵢ.

The equivalent circuit is also suitable without restriction for correctly calculating the electrical variables for asymmetric operation.

Some embodiments may be configured to set the radiation power of the arcs in such a way that the radiation losses due to reduced shielding of the individual arcs and the thus induced excessive heating of the cooling panels (hot spots) are avoided.

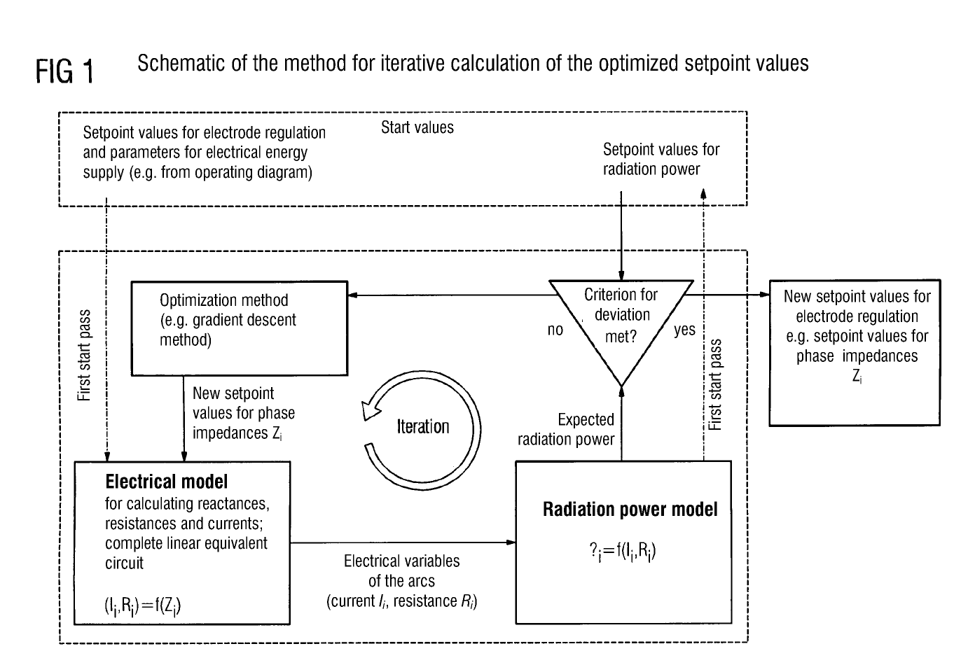

Toward that end, a calculation method has been provided to which the radiation power setpoint values to be set for the three arcs are passed. This is outlined in FIG. 1 and explained in the following.

For this purpose the absolute radiation power is referred to the variable specified in each case for the strand in the operating diagram. For the calculation of the reference values Φ^{FD} referred to operating diagram: Φ₁^{FD}, Φ₂^{FD}, Φ₃^{FD}, the method must be performed in a single pass according to the outer dashed arrows in FIG. 1. The radiation power of the arcs is modified relative to said reference value. The modification is determined from the regulating system in accordance with the calculated shielding factors (for control and/or regulation rule, see above-cited patent application). In principle the following applies: High shielding: radiation power can be increased, low shielding: radiation power must be reduced.

The setpoint value specifications for the radiation power are yielded from

Φᵢ^{Setpoint}=Φᵢ^{FD}·kᵢ

with correction factors ki from the regulating concept for the shielding (see above-cited patent application).

Since the radiation power is a function of the arc voltage and current and the algorithm for the electrical equivalent circuit cannot be inverted, said electrical setpoint value specifications must be determined by means of an iterative method, as schematically depicted in FIG. 1.

It is necessary to find the impedance setpoint values or parameters corresponding to the impedances, for which the quantitatively predefined radiation power of the arcs is set. The iterative mathematical path is indicated in FIG. 1. New, varied setpoint value specifications are generated using a standard optimization method (e.g. gradient descent method). This is used to calculate the associated arc currents and voltages and the associated radiation powers Φᵢ^{Calculated} are determined in the radiation module. The criterion for the maximum permitted deviation between calculated radiation power Φᵢ^{Calculated} and the setpoint value for the radiation power Φᵢ^{Setpoint} can be specified, e.g. based on the sum of squared errors. If the sum of squared errors

$$E = {\sum }_{i = 1}^{3} {( {Φ}_{i}^{Calculated} - {Φ}_{i}^{Setpoint} )}^{2}$$

exceeds a previously specified limit value, then the setpoint value specification, e.g. the impedances Zᵢ, is iteratively adjusted by way of the standard optimization method until the condition is satisfied. In this case the newly found setpoint values, e.g. the impedances (Z₁, Z₂, Z₃), are output to the electrode regulating system. Whether a valid solution to this problem can be found is dependent here on the specifications in the individual case. This is explained below.

It is now shown, for an electrode regulating system based on the strand impedances of a three-phase arc furnace, how certain embodiments can be implemented, e.g., with reference to example graphs.

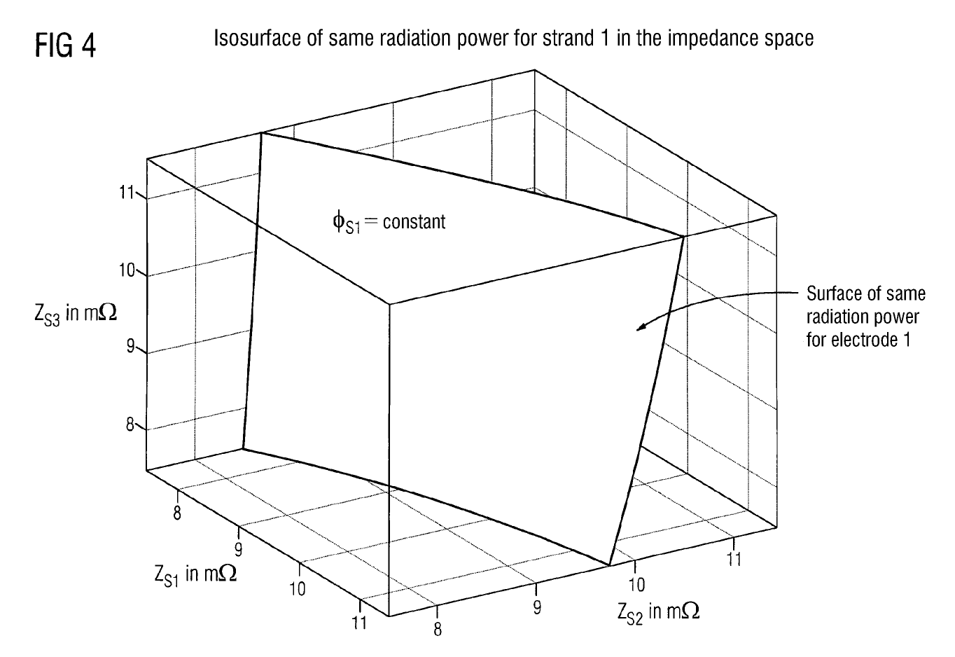

For a given transformer and choke stage, a three-dimensional space is spanned by the impedance setpoint values as remaining actuating variables of the regulating system. Each axis of said space is spanned by the impedance setpoint value of a strand. A quantitatively determined radiation power for each arc can now be calculated for every point in this space. If a quantitative radiation power is now specified for an arc, all points in the three-dimensional impedance space that correspond to said radiation power can be represented as an isosurface of equal radiation power; see FIG. 4. In this case Z_{Si} denotes the impedance setpoint value for strand i, and Φ_{Si} the radiation power of said strand. Every point on the isosurface shown represents a combination of impedance setpoint values which leads to the same radiation power of the arc in the strand under consideration (in this case strand 1).

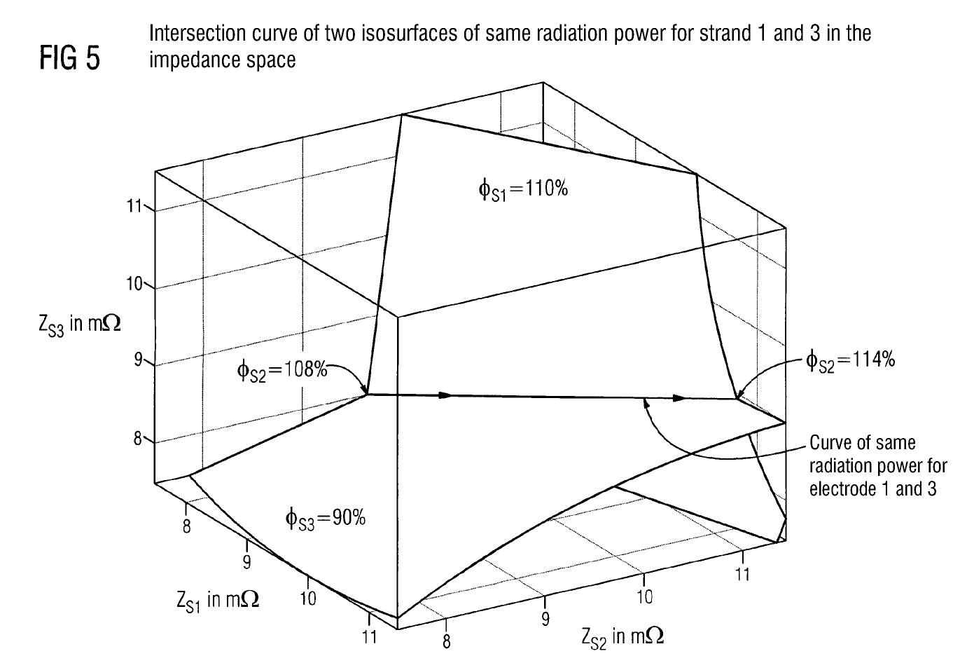

A quantitative, relative radiation power is now specified for each individual strand. The intersecting set of the corresponding isosurfaces corresponds to the associated searched-for combination of impedance setpoint values. Shown by way of example in FIG. 5 is the three-dimensional impedance space in which the isosurfaces of the radiation powers of strand 1 (e.g. Φ_{S1}=110%) and strand 3 (e.g. Φ_{S3}=90%) are specified. The intersection curve of said isosurfaces corresponds exactly to the combinations of impedance setpoint values for which the predefined quantitative radiation powers are achieved. The value range of the relative radiation power of strand 2 on the intersection curve of the isosurfaces lies between 108% and 114% of the original radiation power. In practice-relevant configurations exactly one intersection point is obtained by calculating a third isosurface of the radiation power for strand 2, e.g. where Φ_{S2}=110%. In the case of realizable specifications of the radiation power, the intersection point of the planes (Z₁, Z₂, Z₃) lies in the permissible operating range of the arc furnace. The associated radiation powers coincide exactly with the specified radiation powers of the three strands.

It should be noted that it is not mandatory for the intersecting set of the isosurfaces (=impedance point (Z₁, Z₂, Z₃)) to lie in the permissible range of the impedance setpoint values which is actually suitable for the predefinition for the regulating system. The lower limit is given by the rated currents of the furnace transformer or by the secondary supply line impedances. The upper limit, in contrast, is given by a limiting of the length of the arcs, the radiation power or the stability of the arcs. If the intersecting set of the isosurfaces lies outside of said limits, the specified radiation powers are not suitable for real-world furnace operation. In that event an optimal solution (Z₁, Z₂, Z₃) within the permissible range is used which most closely approximates the required radiation powers and at the same time takes account of the technical limitations. The sum of squared errors can be used for example as the associated quality criterion.

In some embodiments, in contrast to certain known methods, a quantitative radiation power is predefined for each arc, and on that basis the electrical setpoint value specifications for the regulation of the electrodes are calculated correctly. The above calculation method implicitly makes provision for isosurfaces of the radiation power of the arcs to be calculated as a function of the actuating variables and for the electrical setpoint value specifications to be derived in an iterative optimization method in such a way that a distribution that is to be specified for the radiation powers of the three arcs is achieved exactly.

As a consequence the arc furnace can operate with minimum radiation losses, the energy can be optimally allocated to the arcs and the melting feedstock can be melted as uniformly and quickly as possible. This results in a considerable gain in productivity while minimizing consumption of operating resources.

What is claimed is:

1. A method for operating an arc furnace, comprsing:
generating an arc for melting metal using at least one electrode, the arc having a first radiation power based on a first preselected set of operating parameters,
operating the arc furnace according to a predefined operating program based on an expected process sequence,
monitoring to detect whether an undesirable deviation exists between the actual process sequence and the expected process sequence, and
if an undesirable deviation exists:
specifying a modified second radiation power, and
determining a modified second set of operating parameters, based on the modified second radiation power.

2. The method of claim 1, comprising determining the second set of operating parameters iteratively.

3. The method of claim 1, wherein a first model for determining a radiation power from electrical variables is used for the iterative determination.

4. The method of claim 3, wherein a second model is further used for the iterative determination, wherein variables that indirectly influence the radiation power are transformed into electrical variables that directly influence the radiation power.

5. The method of claim 4, wherein for the transformation the second model uses an electrical equivalent circuit for the arc furnace.

6. The method of claim 1, wherein the determination of the modified second set of operating parameters includes accounting for compliance with particular technical limitations of the arc furnace operation.

7. The method of claim 1, wherein the modified second radiation power is specified as a function of a shielding of the arc that is present in the arc furnace.

8. The method of claim 1, wherein the modified second radiation power is specified as a function of a distribution or a degree of fragmentation of metal scrap material in the arc furnace.

9. The method of claim 1, wherein the arc furnace has three electrodes, each associated with an arc, and the method further comprises:
if a deviation exists for at least two of the three arcs, specifying a modified second radiation power for each of said arcs,
determining a second set of operating parameters for at least two of the three arcs based on the modified second radiation power for each respective arc.

10. The method of claim 9, further comprising modifying the radiation power of at least two arcs, wherein the sum of the individual radiation powers of the arcs associated with the three electrodes is substantially the same before and after modification of the radiation power.

11. The method of claim 1, wherein the arc furnace has three electrodes, each associated with an arc, and the method further comprises
if a deviation exists, specifying a modified second radiation power for each arc, and
determining a common set of operating parameters based on said second radiation powers, such that each arc achieves the specified radiation power.

12. The method of claim 1, wherein the radiation power for the three arcs is specified such that a thermal loading of the arc furnace is reduced.

13. A control device for an arc furnace, comprising a machine-readable program code stored in non-transitory computer-readable media and executable by a processor to:
generate an arc for melting metal using at least one electrode, the arc having a first radiation power based on a first preselected set of operating parameters,
operate the arc furnace according to a predefined operating program based on an expected process sequence,
monitor to detect whether an undesirable deviation exists between the actual process sequence and the expected process sequence, and
if an undesirable deviation exists:
specify a mod fled second radiation power, and
determine a modified second set of operating parameters based on the modified second radiation power.

14. An arc furnace for melting metal, comprising:
at least one electrode for generating an arc,
a control device operatively coupled to a device for setting a radiation power and/or variables that influence the radiation power, the control device configured:
generate an arc for melting met using at least one electrode, arc having a first radiation power based on a first preselected set operating parameters,
operate the arc furnace according to a predefined operating program based on an expected process sequence,
monitor to detect whether an undesirable deviation exists between the actual process sequence and the expected process sequence, and
if an undesirable deviation exists:
specify a modified second radiation power, and
determine a modified second set of operating parameters based on the modified second radiation power.

15. The method of claim 1, wherein determining a modified second set of operating parameters based on the modified second radiation power comprises determining at least one impedence value based on the modified second radiation power.

16. The method of claim 4, wherein impedence, which indirectly influences the radiation power, is transformed at least one of current and resistance, which directly influence the radiation power.

17. The method of claim 11, wherein determining a common set of operating parameters based on said second radiation powers comprises determining impedence values based on said second radiation powers.

18. The method of claim 1, wherein the radiation power for the three arcs is specified such that a thermal loading of cooling elements of the arc furnace is reduced.
